(19) United States
(12) Patent Application Publication
(10) Pub. No.: US 2002/0019877 A1
(43) Pub. Date: Feb. 14, 2002

(54) Method and system for transmitting data

(76) Inventor: Juergen Wrede, Bietigheim-Bissingen (DE)

Correspondence Address: KENYON & KENYON, ONE BROADWAY, NEW YORK, NY, 10004, US

(21) Appl. No.: 09/920,588

(22) Filed: Aug. 1, 2001

(30) Foreign Application Priority Data
Aug. 4, 2000 (DE) 100 38 096.4

(51) Int. Cl. G06F 15/16; G06F 7/00; G06F 17/00

(52) U.S. Cl. 709/230; 701/2; 709/203

(57) ABSTRACT

A method for transmitting data, particularly programs or software, between a data processing unit on the provider side, particularly a server, and at least one data processing unit on the user side, particularly a programmable control unit in a motor vehicle. The provider-side data processing unit and the user-side data processing unit being, in each case, operatively connected to a transmitting/receiving device for the wireless transmission and/or reception of data. After transmission from one of the transmitting/receiving devices to the respective other transmitting/receiving device, the data is initially sent to a buffer storage, and is input or loaded into the specific data processing unit only during the existence of a predefined operating state on the user side or on the provider side.

### FIELD OF THE INVENTION

The present invention relates to a method and a system for transmitting data, particularly for loading or updating programs, between a data processing unit on the provider side, particularly a server, and a data processing unit on the user side, particularly a programmable control unit in a motor vehicle.

### BACKGROUND INFORMATION

Today's motor vehicles generally have a multitude of electronic systems which are controlled via software programs or data records. When working with such electronic systems, in certain cases it is necessary or desirable to subsequently change or completely replace the software programs or data records of the electronic control units in the field or in use, i.e., located at the customer or a service organization; for example if an error is determined later in the software of an electronic system.

Difficulties usually result in this case, since, for example, all control units in the field must be reached. This measure is significant particularly in the case of errors relevant to safety. It is also desirable to carry out a necessary data transmission or data exchange as quickly as possible. Furthermore, in the event, for example, of a necessary recall campaign for implementing such a data exchange, not only enormous costs arise, but such recall campaigns can also lead to customer anger and a loss in prestige.

Conventionally new software is distributed to the service stations via a service organization of the manufacturers or suppliers, for example, by CD-ROM or Internet. As soon as the vehicles/units, recalled or coming in at the normal service interval, are in the service station, the new software can then be loaded or “flashed” into the control unit via PC-diagnostic programs at hand. The control unit in question is subsequently marked, for example, with a sticker which identifies and documents the newly loaded software variant.

It is likewise conventional for data or statuses of programs to be changed via radio in units situated far apart geographically, for example, a change from winter to summer time in the case of radio clocks. The teleservicing of engines and systems via wireless or mobile telephone connections is equally familiar.

Furthermore, motor vehicles equipped with car radios or mobile telephones, i.e. radio receivers, such radio receivers are increasingly linked via data buses to the electronic control unit, for example, for the drive or for the control of an ABS system. Thus, a simple data exchange between the radio receivers and a control unit is already being made available in conventional motor vehicles.

German Patent Application No. 197 50 364 describes a method for updating information stored in a communications terminal provided for mobile use. This patent describes that it is possible to update the stored information via radio using a transmitting and receiving antenna.

In addition, German Patent Application No. 197 50 372 describes a method for loading programs and/or data into a data processing unit in a motor vehicle. In this case, programs and/or data are loaded from a server of a provider into the data processing unit of a user, in that the server of the provider and the data processing unit are each connected to a transceiver, and in response to a request by the user, a radio link is established between user and provider via which identification data for checking an access authorization is transmitted by the user, and programs and/or data requested by the user are subsequently loaded into the unit of the user.

In such a data transmission, it proves to be problematical that during the data transmission, a control unit affected by the reprogramming must be retained in a precisely defined state, e.g., a standby state, which may not be changed during the transmission process. During these transmission times, the affected control unit is not fit for use without restriction, which, for example, can lead to safety risks.

### SUMMARY

An object of the present invention is to permit the simplest possible reprogramming of control units provided within the framework of a motor vehicle, it being the intention to avoid functional impairments of the control unit and of the motor vehicle during the reprogramming.

According to an example embodiment of the present invention, it is possible to ensure in a simple manner that a reprogramming of a control unit carried out via radio or in a wireless manner does not lead to inexplicable or tiresome delays for the driver/operator, or to functional impairments of the control unit and vehicle, respectively. The buffer storage, according to the example embodiment of the present invention, of the transmitted data and its copying onto the respective data processing units only during the existence of a predefinable operating state permits, for example, programming of control units on the user side or vehicle side without functional impairments or delays arising during the programming. It should be noted that the designation transmitting/receiving device is intended to include all provider-side and user-side possibilities particularly a transmitting and receiving device on the provider side and user side, or a transmitting device on the provider side and a receiving device on the user side.

According to one example embodiment of the method of the present invention, an operating state of the motor vehicle is selected as the predefinable operating state on the user side. Due to this measure, the example method is usable such that usage impairments of the motor vehicle can be ruled out.

The state in which the vehicle is stationary and/or with the parking brake set and/or ignition switched off and/or ignition key withdrawn is expediently selected as the predefined operating state. These means can ensure that a control unit contained in the vehicle is programmed only when the vehicle is not in operation.

A power supply of the user-side data processing unit and/or of the storage buffer is advantageously maintained for a presettable time after switching off the ignition or withdrawing the ignition key. Due to this measure, a control unit on the vehicle side can also still be newly programmed or reprogrammed for a certain time after withdrawing the ignition key.

According to a further example embodiment of the method of the present invention, the buffer storage is operatively connected to a central vehicle computer, or is constructed as part of this central vehicle computer.

Such a central vehicle computer is effectively able to check, record and temporarily store the transmitted data. The central vehicle computer can also have the ability to document the reprogramming, e.g., with identification codes, or to acknowledge to the provider side. The central vehicle computer detects the state of the vehicle via various sensor signals, e.g., a speed sensor or engine r.p.m. counter (connected directly or via a data bus to the further control units).

The central vehicle computer is expediently connected via a bi-directional data bus to at least one of the data processing units on the user side. Such a bi-directional data bus ensures problem-free data transmission between the central vehicle computer and data processing units to be reprogrammed. Furthermore, it is possible to indicate the status of the respective data processing units to the central vehicle computer via such a data bus.

According to an example embodiment of the method of the present invention, the data processing units on the user side include an engine management, an ABS system, an electronically controlled braking (ELB) system, an electronic stability program, an electronic pneumatic suspension, a transmission-shift control and a retarder control.

### BRIEF DESCRIPTION OF THE DRAWINGS

FIG. 1 shows schematically a central transmitting terminal as a unit on the provider side, and a motor vehicle in which a number of control units are provided as data processing units on the user side.

FIG. 2 shows schematically a flow chart for representing an example embodiment of the method according to the present invention.

### DETAILED DESCRIPTION

In the exemplary embodiment shown, a peripheral control unit is used as a data processing unit on the user side. The representation is also valid in analogous manner for a central controller or for a central vehicle computer, as well. The method of the present invention is furthermore useable in connection with a data transmission from a motor vehicle to a central device on the provider side. Here as well, it is possible that the transmitted data is initially buffered.

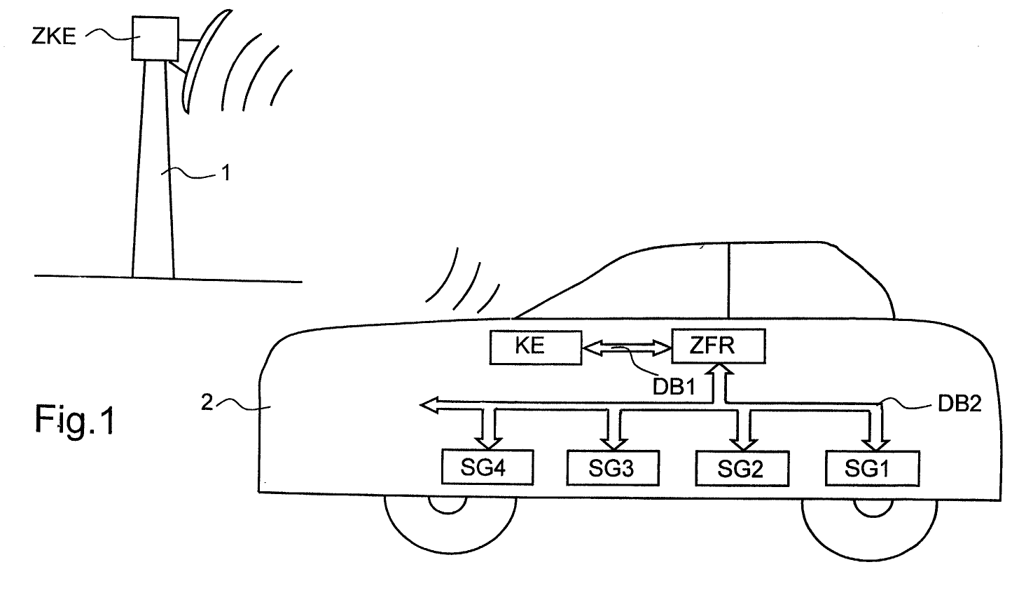

If, for example, improved software is to be given to a control unit on the vehicle side, a corresponding data transmission is carried out from an authorized transmitting terminal of the manufacturer, which in FIG. 1, is constructed as central transmitting terminal 1. In this case, the central transmitting terminal is constructed having a transmitting and/or receiving device ZKE. The motor vehicle 2 has a communications device, i.e. transmitting and/or receiving device KE, which is able to receive the transmitted data. Communications device KE can be constructed, for example, in the form of a car radio (reception only) or a mobile telephone (bi-directional) or a special telecommunications device having a transceiver which is permanently installed in the vehicle.

Communications device KE routes the transmitted program data via a data bus DB1 to a central vehicle computer ZFR, in which the data is checked, recorded and buffered. Central vehicle computer ZFR is connected via a second bi-directional data bus DB2 to the peripheral control units on the user side actually to be programmed, i.e. destination control units SG1, SG2, etc., for the data or program exchange. For example, the engine management, an ABS system, an ELB system, an electronic stability program, an electrical pneumatic suspension, a transmission-shift control or a retarder control can be control units.

Central vehicle computer ZFR detects the status of the vehicle, e.g., whether the vehicle is at standstill or in a traveling state, via various sensor signals, for example, a speed sensor or an engine r.p.m. counter (directly or via the data bus to one of the other control units). It can also be determined, for example, whether the engine is running, a parking brake is engaged or the ignition key is inserted. Moreover, the status of individual control units SG1, SG2 is known to the central vehicle computer via data bus DB2. A prerequisite for the central vehicle computer initiating the reprogramming of one of control units SG1, SG2, etc. is a secure or safe state of the vehicle and the readiness of a specific control unit to receive. For this purpose, each control unit sends a precisely defined status signal to the central vehicle computer via data bus DB2. During the reprogramming, the control unit in question enters into a precisely defined standby state which cannot be changed during the programming process. A programming is expediently carried out as quickly as possible, e.g., within a few seconds.

So that no inexplicable delays arise for the driver or operator of the motor vehicle, a vehicle state is advantageously selected in which no inconvenience or disadvantages result for the driver during a programming. It proves to be particularly advantageous to select a state in which the vehicle is stationary, the parking brake is engaged, the ignition is switched off and the ignition key is withdrawn. An after-running in the power supply of central vehicle computer ZFR and of control units SG1, SG2, respectively, assures that a reprogramming can be undertaken even for a certain time after removal of the ignition key.

As a further prerequisite for the reprogramming of a control unit, it is advantageous if an identification code for the new program, which was sent to the central vehicle computer, be compared to an identification code of the original software stored in a control unit SG and exchanged, respectively. Only when both identification codes have been checked by the central vehicle computer and/or the specific control unit and been established in a precisely defined manner as coinciding is the programming operation enabled.

To avoid misuse or an improper reprogramming, it is further possible to incorporate a plurality of passwords or codings in the entire communication chain from central transmitting terminal 1 up to respective control unit SG.

To ensure rapid accessibility of all vehicles in the field, the power supply for communications unit KE and central vehicle computer ZFR can be permanently switched on even when the ignition key is withdrawn, or in each case at specific time intervals which are expediently synchronized with corresponding transmission intervals of transmitting terminal 1.

After reprogramming has been successfully concluded, reprogrammed control unit SG1, SG2, etc., sends an acknowledgment to the central vehicle computer, which passes on a corresponding acknowledgment to communications unit KE. Communications unit KE transmits an acknowledge signal, possibly combined with a vehicle identification signal, to central transmitting terminal 1, the signal being processed and stored in a central database. In this way, a vehicle manufacturer has an overview at any time of the status of a software exchange campaign.

The central vehicle computer also has the task of recording the reprogramming operation and documenting it together with the corresponding identification code. The software to be exchanged or the data to be exchanged can be checked for correct transmission using check sum tests and other tests according to the related art, similarly as is customary for conventional PC programming operations.

In one advantageous embodiment, it is possible to indicate to the driver or user via a display that it is necessary to exchange the software in a control unit, and he/she should promptly establish the vehicle state necessary for a corresponding data transmission. For example, in the case of changes relevant to safety, the vehicle standstill can be demanded immediately via a red warning signal.

In an altered and simpler variant, it is possible to transmit from central transmitting terminal 1 to communications unit KE in a vehicle that an error exists in the software of a control unit, a new or corrected software not being transmitted, however. This information can be indicated, for example, by the central vehicle computer to the driver via a display, or a warning can be output which prompts the driver to visit a service station immediately.

The measure according to the present invention of buffering transmitted program data in a central vehicle computer (or even in a specific destination control unit or another suitable memory) makes it possible to decouple the reception of data (permanently possible) from the reprogramming operation (which is only allowed during specific states).

A great number of vehicles can be warned or even reprogrammed within the shortest time on the basis of the method according to the present invention. In doing this, the vehicles do not have to visit a service station. It is possible to implement a reprogramming without a driver thereby experiencing inconvenience or loss of time. For a vehicle manufacturer, the possibility exists of a complete overview as to how many vehicles have been reprogrammed and when.

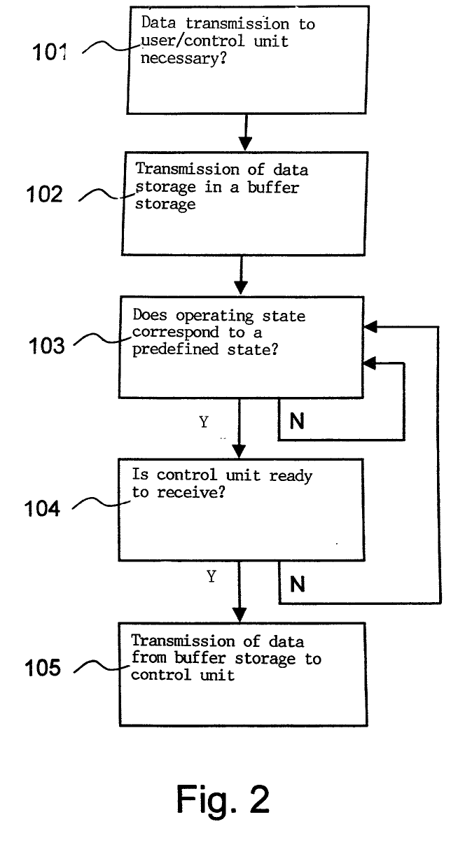

The method of the present invention shall now be described once again on the basis of the flow chart, shown in FIG. 2, of an example embodiment. In a step 101, it is first determined on the provider side that a data transmission to a user has become necessary. In this case, as described above in detail, a data transmission is carried out from transmitting terminal 1 to communications device KE of vehicle 2. From there, the data transmission is routed via data bus DB1 to central vehicle computer ZFR. In a step 102, the data is buffered in the central vehicle computer. The vehicle computer now checks at regular intervals whether the operating state of motor vehicle 2 corresponds to a predefined operating state (step 103). If this is the case, in a step 104 it is determined whether a control unit SG to be reprogrammed is ready to receive. If this is the case, the desired or necessary data transmission is carried out in a step 105. The possibilities of an acknowledgment of the data transmission and a reply to the central transmitting terminal was described above.

However, if it is determined in step 104 that the control unit is not yet ready to receive, a jump is made back to step 103 where it is determined again whether the operating state of the motor vehicle still corresponds to the predefined operating state.

What is claimed is:

1. A method for transmitting data between a respective data processing unit on a provider side and a respective data processing unit on a user side, the respective data processing unit on the provider side and the respective data processing unit on the user side in each case being operatively connected to a respective transmitting/receiving device for at least one of wireless transmission and wireless reception of data, the method comprising:
storing, in a buffer storage, data received from the respective transmitting/receiving device of one of the user side and the provider side; and
loading the stored data into the respective processing unit on the other of the user side and the provider side only during an existence of a predefined operating state on the other of the user side and the provider side.

2. A method for transmitting data between a respective data processing unit on a provider side and a respective data processing unit on a user side, the respective data processing unit on the provider side and the respective data processing unit on the user side in each case being operatively connected to a respective transmitting/receiving device for at least one of wireless transmission and wireless reception of data, the method comprising:
storing, in a buffer storage, data received from the respective transmitting/receiving device of the provider side; and
loading the stored data into the respective processing unit on the user side only during an existence of a predefined operating state on the user side.

3. The method as recited in claim 2, wherein the data is one of a program and software.

4. The method as recited in claim 2 wherein the respective data processing unit on the provider side is a server.

5. The method as recited in claim 2, wherein the respective data processing unit on the user side is a programmable control unit in a motor vehicle.

6. The method as recited in claim 5, wherein an operating state of the motor vehicle is the predefinable operating state on the user side.

7. The method as recited in claim 6, wherein the operating state is at least one of: i) the motor vehicle is stationary, ii) a parking brake is set, iii) an ignition is switched off, iv) a driving switch is turned off, and v) an ignition key is withdrawn.

8. The method as recited in claim 6, further comprising:
maintaining a power supply of the respective data processing unit on the user side for a presettable time after at least one of: i) switching off the ignition, and ii) withdrawing the ignition key of the motor vehicle.

9. The method as recited in claim 2, wherein the buffer storage is one of: i) operatively connected to a central vehicle computer, and ii) constructed as part of the central vehicle computer.

10. The method as recited in claim 9, wherein the data is checked, recorded and buffered by the central vehicle computer.

11. The method as recited in 9, wherein the central vehicle computer is connected via a bi-directional data bus to at least one data processing unit on the user side.

12. The method as recited in claim 2, wherein the respective data processing unit on the user side includes at least one of: an engine management, an ABS system, an ELB system, an electronic stability program, a pneumatic suspension, a transmission-shift control, and a retard control.

13. A system for transmitting data between a respective data processing unit on a provider side and a respective data processing unit on a user side, comprising:
a respective transmitting/receiving unit operatively connected to the respective data processing unit on the provider side to at least one of wirelessly transmit data and wirelessly receive data;
a respective transmitting/receiving unit operatively connected to the respective data processing unit on the user side to at least one of wirelessly transmit data and wirelessly receive data; and
a buffer storage configured to buffer data received from one of the provider side and user side, the buffered data being transmitted to the respective data processing unit on the other of the provider side and user side only during an existence of a predefined operating state on the other of the provider side and user side.

14. The system as recited in claim 13, wherein the data is one of a program and software.

15. The system as recited in claim 13, wherein the respective data processing unit on the provider side is a server.

16. The system as recited in claim 13, wherein the respective data processing unit on the user side is programmable control unit in a motor vehicle

17. The system as recited in claim 16, further comprising:
an arrangement configured to maintain a power supply of at least one of the respective data processing unit on the user side and the buffer storage for a presettable time after at least one of: an ignition is switched off, and an ignition key of the motor vehicle is withdrawn.

18. The system as recited in claim 16, wherein the buffer storage is one of: operatively connected to a central vehicle computer, and constructed as part of the central vehicle computer.

19. The system as recited in claim 18, further comprising:
a bi-directional data bus via which the central vehicle computer is connected to the respective data processing unit on the user side.

20. The system as recited in claim 13, wherein the respective data processing unit on the user side includes at least one of: an engine management, an ABS system, an ELB system, an electronic stability program, a pneumatic suspension, a transmission-shift control, and a retard control.
